(19) United States
(12) Patent Application Publication
(10) Pub. No.: US 2008/0099160 A1
(43) Pub. Date: May 1, 2008

(54) Regulation structure for shutter slats

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/590,764

(22) Filed: Nov. 1, 2006

(51) Int. Cl. E06B 9/30

(52) U.S. Cl. 160/172 R

(57) ABSTRACT

A regulation structure for shutter slats is adopted for a blind shutter which includes a frame and a plurality of shutter slats suspending on the frame. The regulation structure includes a regulation dock, two ratchet gear racks, two compression ratchet gears, a drawing cord, two elastic elements and an actuation means. The ratchet gear racks are fixedly located on two inner sides of the frame. The compression ratchet gears are located on two side ends of the regulation dock and separated by the two elastic elements to push the compression ratchet gears to be latched on the ratchet gear racks and anchored on the frame. The drawing cord has two distal ends fastened to the two compression gears. Through the actuation means the two distal ends of the drawing cord can be driven towards the center thereof to move the two compression gears to escape the ratchet gear racks.

### FIELD OF THE INVENTION

The present invention relates to a blind shutter and particularly to an apparatus to change the position of shutter slats of the blind shutter.

### BACKGROUND OF THE INVENTION

Referring to FIGS. 1 and 2, a conventional blind shutter 1 includes a rectangular frame 2 with a hollow center, a plurality of shutter slats 3 suspending in the hollow center from up and down in an equally spaced manner, and an annular woven band 4 located respectively on the left side and the right side to fasten the shutter slats 3. Turning any one of the shutter slats 3, the woven band 4 can be moved to synchronously drive the shutter slats 3 to swivel to an inclined, closed or open condition.

As the woven band 4 is a pliable fabric and can be moved with the swiveling of any shutter slat, the shutter slats 3 can be stacked from the top to the bottom in an inclined manner as shown in FIG. 2 to minimize the gap between any two shutter slats 3 to fully block airflow and sunshine. When there is a desire to ventilate air and receive sunshine, as the shutter slats 3 are fixedly located on the frame 2, light projection and air ventilation are hindered to some degrees. As a result, such a structure cannot fully meet user's requirements.

### SUMMARY OF THE INVENTION

The primary object of the present invention is to provide a regulation structure for shutter slats to change the position of the shutter slats to achieve optimal air ventilation and light projection for a blind shutter.

The invention is adopted for use on a blind shutter which includes a frame and a plurality of shutter slats suspending on the frame. The regulation structure includes two ratchet gear racks, a regulation dock, two compression ratchet gears, two elastic elements, a drawing cord and an actuation means. The ratchet gear racks are fixedly located on two inner sides of the frame and have respectively saw type teeth formed thereon. The regulation dock is located on the frame and slightly smaller than the frame. The compression ratchet gears have teeth mating the teeth of the ratchet gear racks. The two elastic elements are located on two side ends of the regulation dock. The two compression ratchet gears are separated and pushed by the two elastic elements on two side ends of the regulation dock, and movable outwards to be latched on the two ratchet gear racks so that the regulation dock can be anchored on the frame. The drawing cord has two distal ends fastened to the two compression ratchet gears. The actuation means is located between the two distal ends of the drawing cord to be maneuvered by users when in use. The actuation means can drive the two distal ends of the drawing cord towards the center to draw the two compression ratchet gears to escape the ratchet gear racks.

Thus users can alter the position of the regulation dock on the frame to stack the shutter slats on the regulation dock to improve air ventilation and light projection effect of the blind shutter.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional blind shutter.

FIG. 2 is a schematic view of a conventional blind shutter in a closed condition.

FIG. 3 is an exploded view of the invention.

FIG. 4A is a perspective view of the invention.

FIG. 4B is a cross section taken on line 4B-4B in FIG. 4A.

FIG. 4C is a cross section according to FIG. 4B showing the actuation means in an operating condition.

FIG. 5A is a perspective view of another embodiment of the invention.

FIG. 5B is a cross section taken on line 5B-5B in FIG. 5A.

FIG. 5C is a fragmentary enlarged view according to FIG. 5B.

FIG. 5D is a cross section according to FIG. 5B showing the actuation means in an operating condition.

FIG. 5E is a fragmentary cross section taken on line 5B-5B in

FIG. 5A from another angle.

FIG. 5F is a fragmentary cross section according to FIG. 5E showing the actuation means in an operating condition.

FIG. 6 is a schematic view of the invention in use condition.

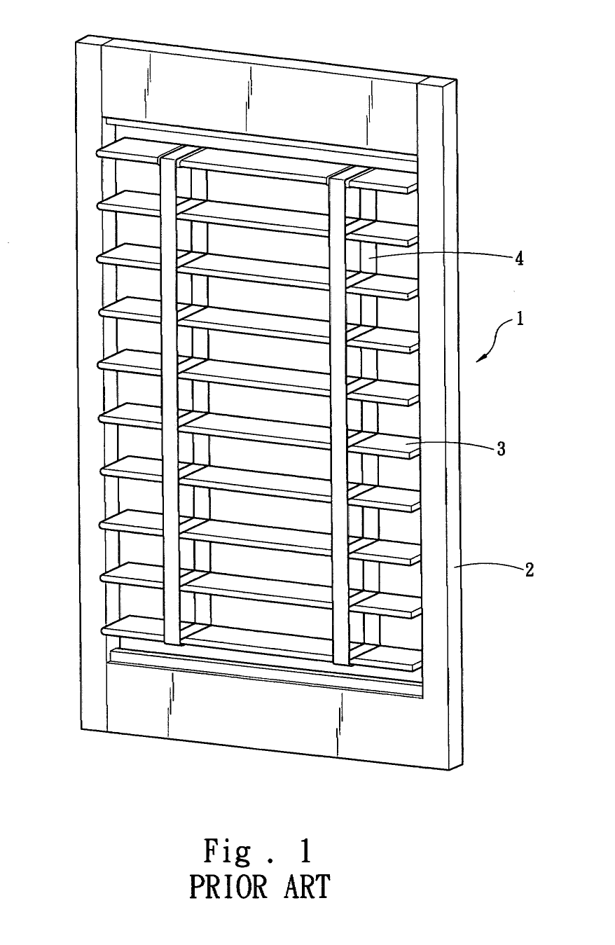

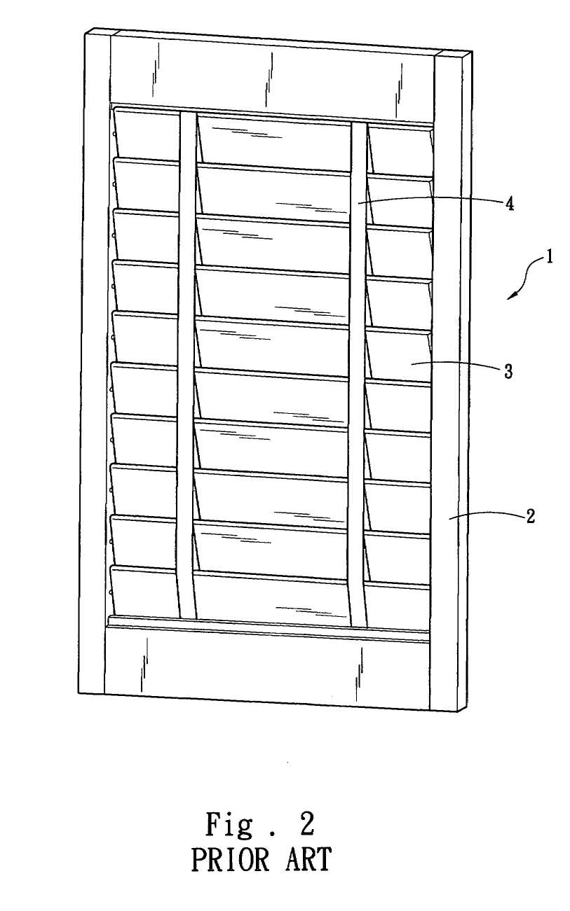

### DETAILED DESCRIPTION OF THE PREFERRED EMBODIMENTS

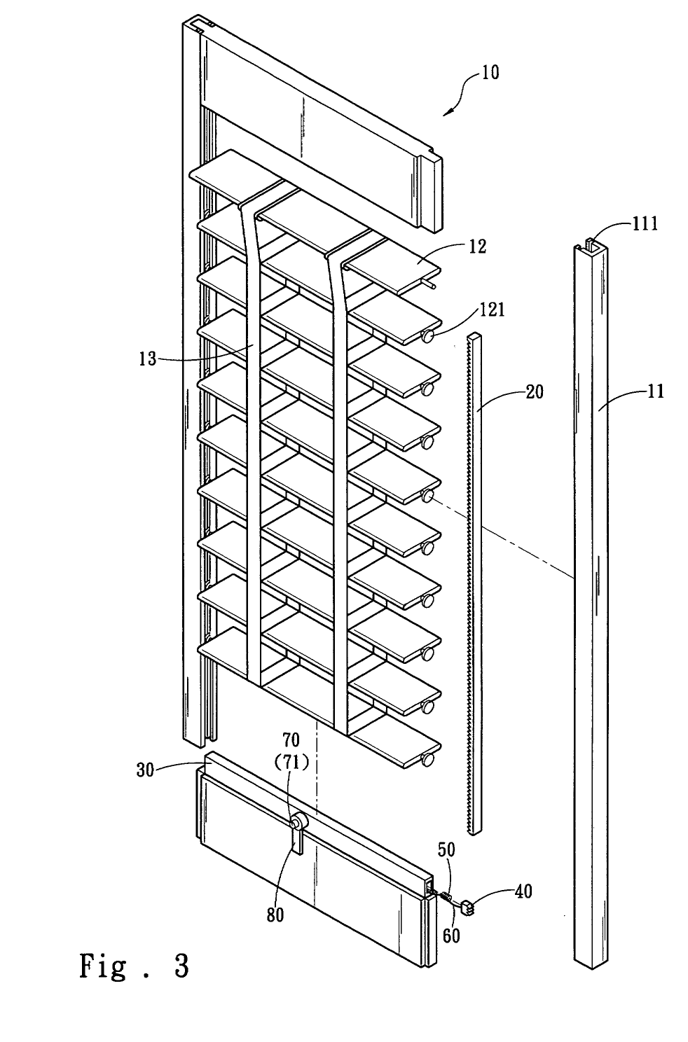

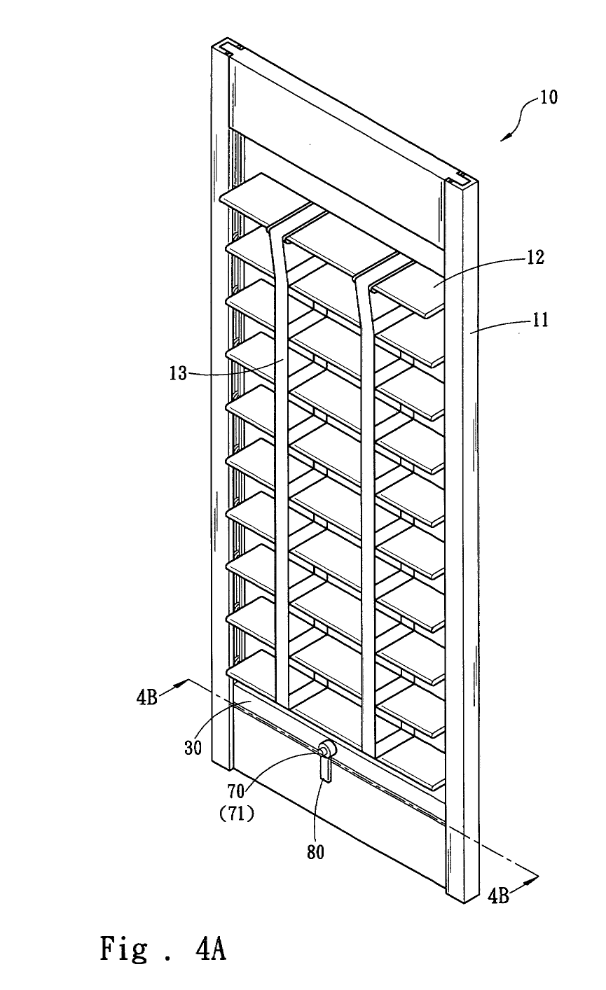

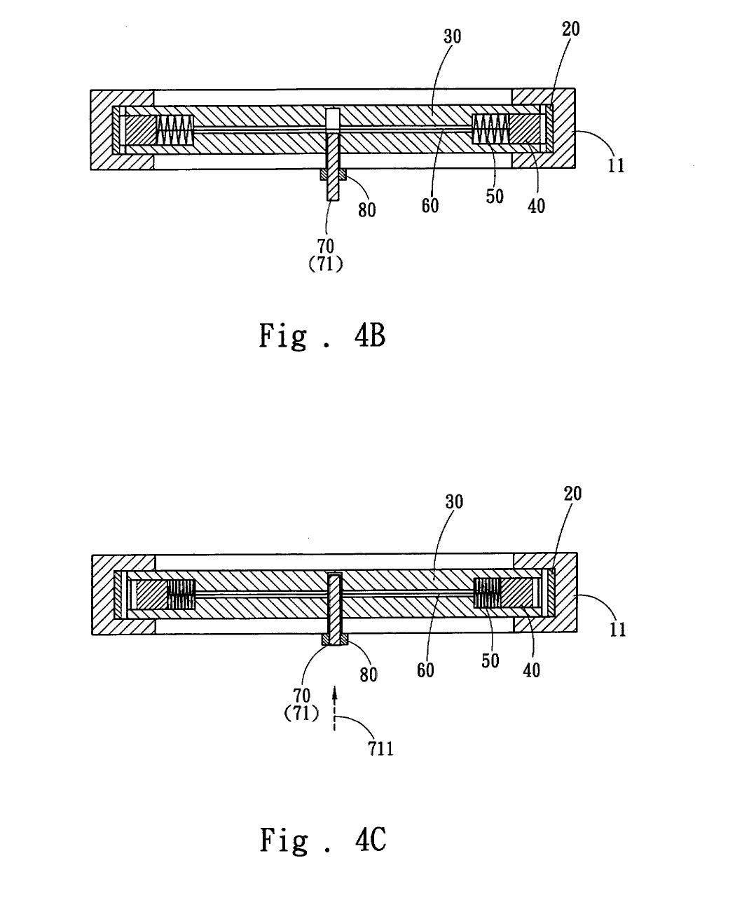

Please refer to FIGS. 3, 4A and 4B, the regulation structure of the present invention is to be used on a blind shutter 10 which includes a frame 11 and a plurality of shutter slats 12 suspending on the frame 11. The regulation structure includes two ratchet gear racks 20, a regulation dock 30, two compression ratchet gears 40, two elastic elements 50, a drawing cord 60 and an actuation means 70.

The ratchet gear racks 20 are fixedly located on two inner sides of the frame 11 and have respectively saw type teeth formed thereon mating the compression ratchet gears 40. The regulation dock 30 is located on the frame and slightly smaller than the frame 11. The two elastic elements 50 are located on two side ends of the regulation dock 30. The two compression ratchet gears 40 are movably located on the two side ends of the regulation dock 30 and separated by the elastic elements 50. The two elastic elements 50 are compressible elastic elements such as springs. The two compression ratchet gears 40 are pushed by the two elastic elements 50 and movable outwards to be latched on the two ratchet gear racks 20 to anchor the regulation dock 30 on the frame 11.

The drawing cord 60 has two distal ends fastened to the two compression ratchet gears 40. The actuation means 70 is located between the two distal ends of the drawing cord 60. The actuation means 70 may be a depressible strut 71 which has a moving displacement 711. The drawing cord 60 passes through the path of the moving displacement 711. The drawing cord 60 may also be fastened to the depressible strut 71.

Also referring to FIG. 4C, when the depressible strut 71 changes the moving displacement 711 (namely the depressible strut 71 is depressed by users and moved), the drawing cord 60 is driven by the depressible strut 71 to move the two distal end towards the center. Hence the actuation means 70 can be maneuvered by users to move the two distal ends of the drawing cord 60 towards the center to move the two compression ratchet gears 40 to escape the ratchet gear racks 20.

The regulation dock 30 may also have a handgrip 80 to be grasped by the users. The handgrip 80 may be an elongate handle. The depressible strut 71 is located on the top end of the handle so that when the users grasp the handgrip 80 their thumb can depress the depressible strut 71.

It is to be noted that the frame 11 has a latch flute 111. The upmost slat of the shutter slats 12 is directly hinged on the frame 11. The lower shutter slats 12 are engaged respectively in the latch flute 111 through a latch ring 121, and are suspended on the frame 11 through a woven band 13. By driving of the woven band 13, the inclined angle of the shutter slats 12 can be changed. Except the upmost slat the rest of the shutter slats 12 can be moved up and down.

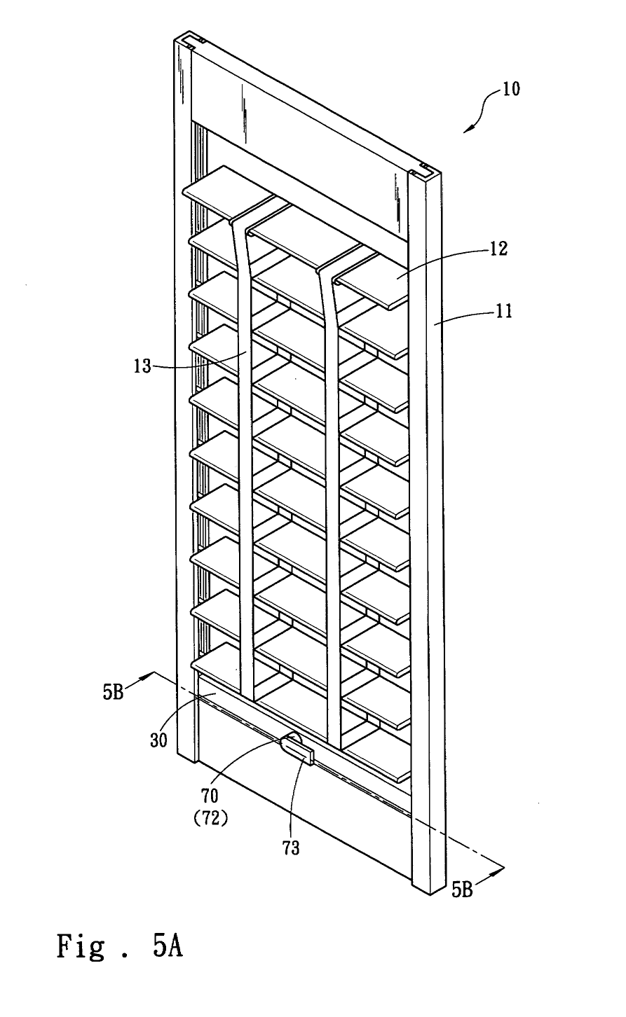

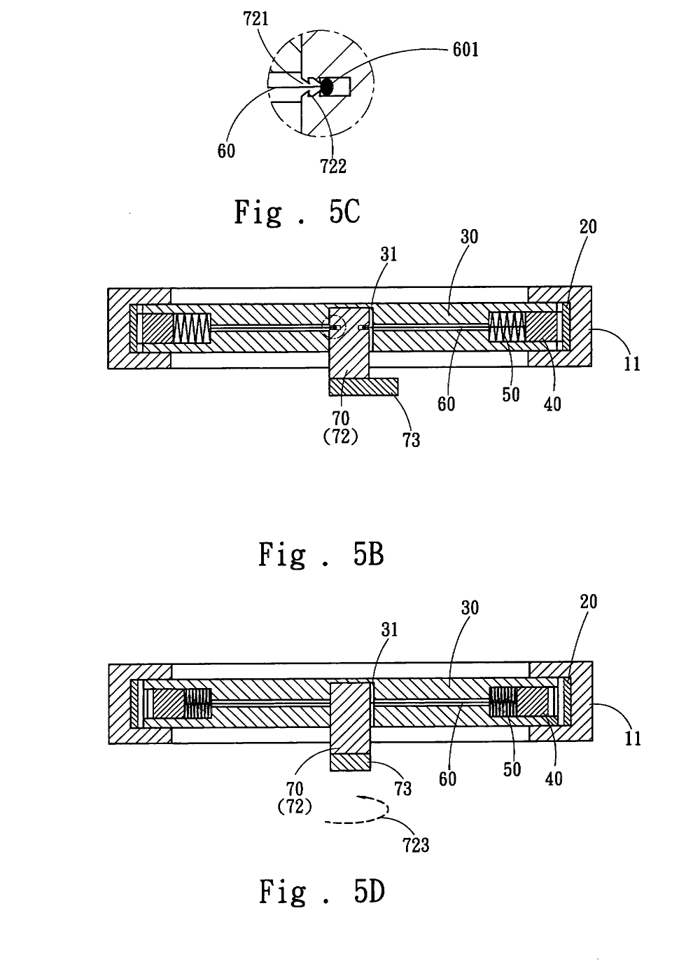

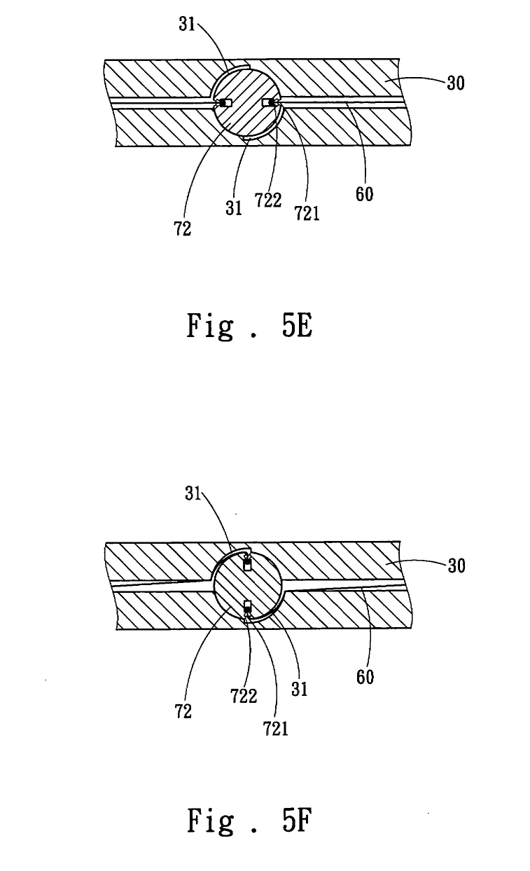

Refer to FIGS. 5A through 5F for another embodiment of the invention. The actuation means 70 may also be a rotary strut 72 inserting in the regulation dock 30 and has a transverse handgrip 73. The rotary strut 72 has two opposite sides each has a fastening trough 721 directing inwards. The fastening trough 721 has a plurality of retraction stopping latch hooks 722 inside. The drawing cord 60 has two sections. The distal section is wound to form a knot 601 to be inserted into the fastening trough 721 and fastened to the rotary strut 72. The rotary strut 72 further has a rotation displacement 723. The regulation dock 30 also has a housing trough 31 corresponding to the fastening trough 721 of the rotary strut 72 in the rotation displacement 723.

When the rotary strut 72 is turned, it drives the drawing cord 60 to enter the housing trough 31 (referring to FIG. 5F), thereby the two distal end of the drawing cord 60 are moved towards the center. Hence the two compression ratchet gears 40 are driven to escape the ratchet gear racks 20.

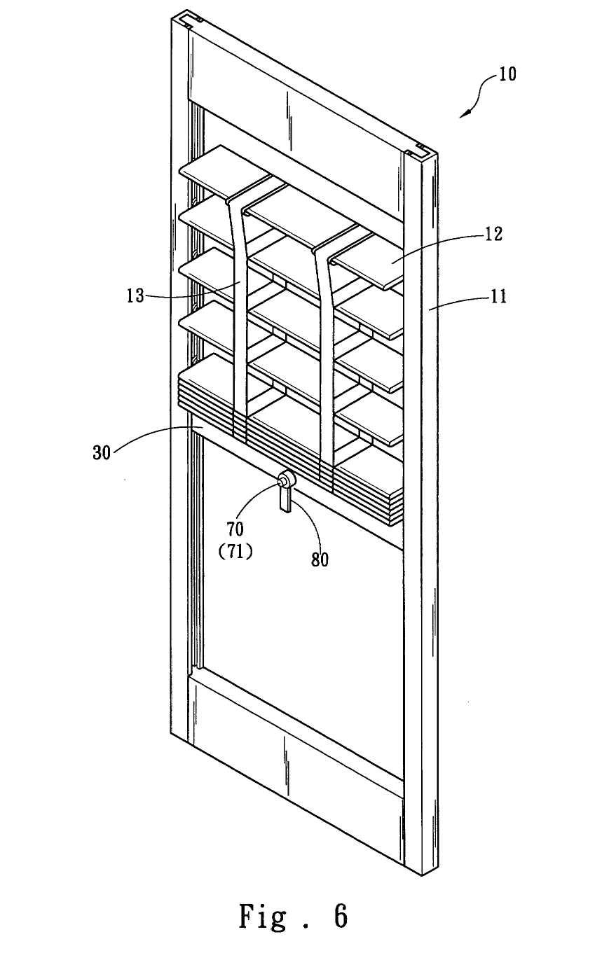

Referring to FIG. 6, when the drawing cord 60 is driven by the actuation means 70 to move the two distal ends towards the center, the two compression ratchet gears 40 are driven to escape the ratchet gear racks 20. Then the regulation dock 30 can be moved up and down as desired to change the position of the regulation dock 30 on the frame 11. Namely users can adjust the position of the regulation dock 30 on the frame 11 according to their requirements. Thereby the shutter slats 12 can be stacked on the regulation dock 30 to improve air ventilation and light projection effect of the blind shutter 10 to meet users' requirements.

What is claimed is:

1. A regulation structure for shutter slats to be used on a blinded shutter which includes a frame and a plurality of shutter slats suspending on the frame, comprising:
two ratchet gear racks which have saw type teeth and are fastened to two inner sides of the frame;
a regulation dock which is located on the frame and smaller than the frame;
two compression ratchet gears which have a teeth profile mating the teeth of the ratchet gear racks;
two elastic elements which are located on two side ends of the regulation dock to separate the two compression ratchet gears such that the two compression ratchet gears are movably located on the two side ends of the regulation dock and pushed by the two elastic elements to move outwards and latch on the two ratchet gear racks to anchor the regulation dock on the frame;
a drawing cord having two distal ends fastened to the two compressing ratchet gears; and
an actuation means located between the two distal ends of the drawing cord to be maneuvered by users to drive the two distal ends of the drawing cord towards the center thereof so that the two compression ratchet gears are driven to escape the ratchet gear racks.

2. The regulation structure for shutter slats of claim 1, wherein the actuation means is a depressible strut located on the regulation dock and had a moving displacement, the drawing cord passing through the path of the moving displacement, the depressible strut altering the moving displacement and driving the drawing cord to move the two distal ends thereof towards the center.

3. The regulation structure for shutter slats of claim 2, wherein the regulation dock has a handgrip fastened thereon.

4. The regulation structure for shutter slats of claim 3, wherein the handgrip is an elongate handle and the depressible strut is located on a top end of the handle.

5. The regulation structure for shutter slats of claim 2, wherein the drawing cord is fastened to the depressible strut.

6. The regulation structure for shutter slats of claim 1, wherein the actuation means is a rotary strut which is located on the regulation dock, the drawing cord being fastened to the rotary strut which has a rotation displacement such that the drawing cord is driven by the rotary strut to move the two distal ends thereof towards the center.

7. The regulation structure for shutter slats of claim 6, wherein the rotary strut has a transverse handgrip.

8. The regulation structure for shutter slats of claim 6, wherein the rotary strut has two opposite sides each having a fastening trough which has a plurality of retraction stopping latch hooks located inside, the drawing cord having two sections and each of the distal ends being wound to form a knot to be inserted into the fastening trough and fastened to the rotary strut.

9. The regulation structure for shutter slats of claim 8, wherein the regulation dock has a housing trough corresponding to the fastening trough of the rotary strut in the rotation displacement.

10. The regulation structure for shutter slats of claim 1, wherein the elastic elements are springs.
